(19) United States
(12) Patent Application Publication
(10) Pub. No.: US 2025/0154017 A1
(43) Pub. Date: May 15, 2025

(54) METHOD OF DIRECT LITHIUM HYDROXIDE PRODUCTION FROM LITHIUM-ION BATTERY WASTE

(71) Applicants: Wook Jin CHUNG, Seoul (KR); SEM Inc., Gyeonggi-do (KR)

(72) Inventors: Wook Jin CHUNG, Seoul (KR); Nisola GRACE, Gyeonggi-do (KR); John Edward SIO, Gyeonggi-do (KR)

(21) Appl. No.: 18/901,271

(22) Filed: Sep. 30, 2024

(30) Foreign Application Priority Data
Nov. 14, 2023 (KR) 10-2023-0157611
Nov. 28, 2023 (KR) 10-2023-0168622

(51) Int. Cl. C01D 15/02; C01D 1/30; C01D 1/32; C22B 26/12; H01M 10/54

(52) U.S. Cl. CPC C01D 15/02; C01D 1/30; C01D 1/32; C22B 26/12; H01M 10/54; C01P 2002/72

(57) ABSTRACT

Disclosed is a method for manufacturing lithium hydroxide from a lithium-ion battery waste. The method includes heat-treating the cathode scraps as the lithium-ion battery waste under an NH₃ gas atmosphere to convert lithium incorporated in the cathode scraps into lithium oxide (Li₂O) or lithium hydroxide (LiOH). The lithium is then leached using water, followed by solid/liquid separation to remove solid residues. CaO is added to the filtered leached solution to precipitate impurities, which are removed before passing the solution through ion exchange resin. After evaporation, crystallization is achieved either by adding isopropyl alcohol or using an evaporative crystallizer, yielding high-purity LiOH·H₂O crystals. This process offers an efficient recycling method for lithium-ion batteries with high lithium recovery and purity.

### CROSS-REFERENCE TO RELATED APPLICATIONS

This application claims the benefit of and priority to Korean Patent Applications No. 10-2023-0157611 and 10-2023-0168622, filed on November 14 and Nov. 28, 2023. The entire disclosure of the applications identified in this paragraph are incorporated herein by references.

### TECHNICAL FIELD

The present disclosure relates to a method of manufacturing lithium hydroxide from a lithium-ion battery (LIB) waste, particularly to a method that selectively extracts lithium hydroxide from the thermally treated LIB cathode scraps containing lithium transition metal oxides that are reduced under ammonia gas atmosphere.

### BACKGROUND

As the automotive industry increasingly shifts from fossil fuel-powered to electric vehicles (EVs), LIBs play an essential role in enabling this transition. The number of electric vehicles (EVs) on roads is projected to increase from 9.67 million in 2022 to approximately 59.01 million in 2030, equivalent to an annual growth rate of 28% through 2050 [SK Industry Analysis, 2021].

With the expansion of the electric vehicle market, it is expected that lithium carbonate (Li₂CO₃) and other essential materials for LIB manufacturing will be insufficient, and solving such a problem is a major challenge. The demand for Li₂CO₃ is expected to surpass supply by 2027, with an estimated demand of 2.15 million tons, while supply is expected to be limited to 1.85 million tons.

The pre-dominant precursor compound that is used in the synthesis of the cathode material is Li₂CO₃ but was revealed to have a problem in recent research. For example, the synthesis of a nickel-manganese-cobalt (NMC) cathode material using Li₂CO₃ requires a high temperature of 850 to 900° C. There is a risk that, at such a high temperature, the crystal structure of the cathode material may be decomposed, and the oxidation state of nickel may be changed. Accordingly, battery performance may be reduced. In terms of such an issue, there is a remarkable change, which is to use lithium hydroxide monohydrate (LiOH·H₂O). The lithium hydroxide monohydrate is a precursor having much higher reactivity than Li₂CO₃ and enables synthesis of NMC cathode material at a low temperature range of 650° C. to 700° C. A treatment process at such a low temperature maintains the crystal structure of the cathode material, expands the life cycle of a battery, and improves the safety of a battery [Fitch and Yakovleva, 2017]. Moreover, LiOH·H₂O reduces the emission of greenhouse and toxic gases while the cathode material precursor is sintered. As a result, LiOH·H₂O is anticipated to surpass Li₂CO₃ as the preferred lithium compound in future LIB production, owing to its advantages in the cathode material manufacturing process. It is expected that the annual production of LiOH will increase from 110,000 metric tons in 2021 to 1.70 million metric tons in 2030.

Most of the conventional methods are designed so that Li₂CO₃ is frequently produced in the final step of a recovery process. Accordingly, a method of directly producing LiOH from LIB waste is still in its initial stage and is not commonly practiced in the industry. For example, industrial hydrometallurgy (e.g., Brunp, GEM, GHTECH, and SungEel HiTech) involves complete reduction and dissolution of a cathode material in reduced acids (HCl or H₂SO₄+H₂O₂). As a result, this process results in a mixed solution of lithium and transition metal salts nickel (Ni), cobalt (Co), and manganese (Mn) being preferentially recovered. Lithium is frequently collected as Li₂CO₃ in the final step through precipitation. Such an approach becomes complicated frequently because reagent addition from previous steps reduces the Li₂CO₃ prior its recovery. Moreover, the complex characteristics of the medium with accumulated reagent ions (e.g., Na⁺ and Ca²⁺) reduce the recovery rate and affects the purity of Li₂CO₃. Accordingly, the existing hydrometallurgical method frequently includes several steps before Li₂CO₃ product is obtained and does not provide direct lithium hydroxide production. In this viewpoint, the best method is to enable lithium, that is, lithium hydroxide, to be collected at the initial step of a recycling process.

The selective extraction of lithium from LIB waste, such as black mass or cathode scraps, is achieved by many researches and inventions that mostly include thermo-chemical reactions. The principle of such inventions is to reduce an active substance at a high temperature of 700° C. to 1000° C. In particular, transition metals (TM) in the layered oxides of NMC are reduced into forms having lower oxidation number, whereas lithium maintains its oxidation state (+1) as Li₂O. However, as carbon is frequently used as a reducing agent, the generation of carbon dioxide rapidly changes Li₂O into Li₂CO₃ in situ. Such a method provides a simpler path along which lithium is selectively collected through water leaching whereas the reduced transition metal oxide is collected as a water-insoluble solid. However, in these methods, the Li⁺ is still collected in the form of Li₂CO₃ as the final product.

As the first step of collection, the most recent inventions for achieving direct lithium hydroxide production have employed H₂ as a reducing agent [KR101497041B1, WO2020011765A1]. In the absence of CO₂ gas, the Li₂O formed by thermo-chemical reduction of NCM by H₂ gas is preserved. The Li₂O may be eluted as LiOH through water leaching while the reduced transition metal oxides are recovered as water-insoluble solid residues. However, the results of such inventions frequently lead to low to moderate lithium leaching efficiencies. For example, in KR101497041B1, when cathode scraps are supplied with 1 L·min⁻¹ of 99% H₂ gas for 1 hour, the maximum leaching efficiency for lithium is 78% at 500° C. In another patent [WO2020011765A1], the maximum lithium leaching efficiency is 65% when supplied with 100% H₂ gas treated at 400° C. for 45 mins. Some lithium is eluted as Li₂CO₃ mixed with LiOH, particularly, 105 mg of CO₃²⁻ of along with 289 mg of OH and 166 mg of Li in a 50 mL solution.

Ammonia (NH₃) is a versatile chemical, widely used across various industries. It serves as a crucial nitrogen source in fertilizers due to its high nitrogen content and plays a pivotal role in metallurgy. In particular, NH₃ is essential in the nitriding process, where it introduces nitrogen into metal surfaces, enhancing their hardness and significantly improving resistance to wear and corrosion. Additionally, NH₃ is extensively used in the environmental management of industrial emissions. In selective catalytic reduction (SCR) systems, operating at 300-400° C., NH₃ reacts with nitrogen oxides (NOₓ), harmful pollutants in exhaust gases, converting them into nitrogen (N₂) and water vapor in the presence of metal catalysts. This process is vital for meeting environmental regulations, as it significantly reduces NOₓ emissions from power plants and automotive exhaust systems. Although NH₃ is a less potent reducing gas than H₂, it remains effective in reducing metal oxide at a lower temperature. Moreover, ammonia is safer to handle compared to hydrogen gas and can be easily transported. In liquid form, NH₃ is relatively easier to store in significantly larger quantities per unit volume compared to hydrogen. In contrast, hydrogen requires high-pressure tanks and ultra-low temperatures for effective storage.

### SUMMARY

Various embodiments are directed to providing a method of producing LiOH from LIB waste, particularly from cathode scraps. This method directly recovers lithium, specifically producing lithium hydroxide, by utilizing ammonia gas as a reducing agent during a thermo-chemical treatment of LIB waste cathode scraps.

However, the objectives and embodiments of the present disclosure are not limited to those mentioned above. Additional objectives and embodiments, not explicitly described, will become apparent to those skilled in the art from the following detailed description.

In an embodiment, a method of manufacturing LiOH from a LIB waste comprises a thermal reduction step (S10) in which cathode scraps derived from the LIB waste are heat-treated in NH₃ gas atmosphere, followed by a leaching step (S20), where lithium from the heat-treated cathode scraps is recovered as LiOH using water.

According to an embodiment of the present disclosure, the cathode scraps may have Chemical Formula 1.

LiCoₐMn_{b}Ni_{c}Al_{d}O₂ [Chemical Formula 1]
wherein each of a, b, c, and d is 0 or more and 1 or less, and if Li=1, a+b+c+d=1; if Li<1, 1<a+b+c+d<2; whereas if Li>1, 0<a+b+c+d<1.

According to an embodiment of the present disclosure, the method may further include a purging step (S5) of the system by using an inert gas prior to the thermal reduction step (S10).

According to an embodiment of the present disclosure, the reduction step (S10) may include heat-treatment of cathode scraps at a temperature of 300° C. to 700° C. for 20 minutes to 80 minutes.

According to an embodiment of the present disclosure, the method may further include a separation step (S30) of solid transition metal oxide residues from the leached solution containing lithium ions following the leaching step (S20).

According to an embodiment of the present disclosure, the method may further include the addition of CaO to the filtered solution, followed by removal of precipitates (S40) formed through a reaction of trace CO₃²⁻ in the leached solution with CaO in the filtered leached solution.

According to an embodiment of the present disclosure, the method may further include an ion exchange step (S50), in which the filtered solution, after the CaO addition and precipitate removal via filtration (S40), is passed through an ion exchange resin.

According to an embodiment of the present disclosure, the method may further include an evaporation step (S60) of removing impurities by evaporating some of the ion-exchanged solution.

According to an embodiment of the present disclosure, the method may further include a crystallization step or precipitation step (S70) following the evaporation and filtration steps (S60) by adding isopropyl alcohol in the evaporated solution from which the impurities have been removed via filtration (S60).

The method of manufacturing lithium hydroxide from a lithium-ion battery, according to an embodiment of the present disclosure, relates to a thermo-chemical reduction method for LIB waste, including active materials or cathode scraps, using NH₃ gas as a reducing agent. This method effectively reduces the transition metals in the cathode materials to their lower oxidation states, or even to zero-valent transition metals and converts lithium to Li₂O or LiOH. The method of invention achieves a high lithium leaching efficiency, exceeding 90%, with lithium that is selectively recovered as LiOH.

According to an embodiment of the present disclosure, in the reduction step (S10), a supply rate of the ammonia gas may be 100 mL·min⁻¹ to 2 L·min⁻¹.

In an embodiment of the present disclosure, the method for producing LiOH from LIB waste involves heat-treating the waste, such as cathode scraps, at a temperature range of 400° C. to 700° C. in the presence of an anhydrous NH₃ gas. The method enables in-situ formation of Li₂O or LiOH during heat treatment step (S10). Accordingly, LiOH is formed from the reaction between Li₂O and generated water vapor (H₂O). The generated Li₂O or LiOH can be selectively extracted through water leaching (S20) as LiOH because the reduced transition metals (TMO or TM) remain undissolved in water.

The method of manufacturing LiOH from LIB waste, according to an embodiment of the present disclosure, relates to a method of separating water-leached LiOH from the solid residues, in which water-leached LiOH can be collected by performing a series of purification steps, including 1) magnetic separation, filtration, or centrifugation for solid/liquid separation (S30), 2) a CaO reaction for the conversion of trace Li₂CO₃ into LiOH when a small fraction of Li₂CO₃ is present in the leachate (S40), 3) an ion exchange process for the removal of other cations, i.e., a small quantity of contaminants (S50), and 4) a series of evaporations-crystallization steps (S60-S70), which may or may not involve the use of isopropyl alcohol (IPA) as an anti-solvent, to obtain LiOH·H₂O product.

### BRIEF DESCRIPTION OF THE DRAWINGS

FIG. 1 is a diagram schematically illustrating the method of producing LiOH from heat-treated cathode scraps as LIB waste using NH₃ gas for thermal reduction.

FIG. 2 is an XRD spectrum of LIB waste cathode scrap (CS-7) confirmed as NMC, based on reference spectra of NMC cathode materials.

FIG. 3 is the SEM-EDS map of LIB waste NMC cathode scrap CS-7.

FIG. 4 is a graph illustrating the particle size distribution of the NMC cathode scraps.

FIG. 5 is a diagram illustrating thermal reduction equipment (furnace or rotary kiln) for cathode scraps using NH₃ gas for the reduction and N₂ for purging and as carrier gas.

FIG. 6 shows the images of actual pristine CS-7, heat-treated CS-7, and CS-7 residues after water leaching.

FIG. 7 shows the SEM images of pure residues, thermally-reduced residues, and water-leached residues of CS-7 cathode scrap.

FIG. 8 shows the XRD spectra of heat-treated CS-7 at 550° C. at different process times supplied with 0.5 L min⁻¹ NH₃ gas.

FIG. 9 is a graph illustrating leaching efficiency of lithium using water from heat-treated CS-7 at different durations of thermal reduction.

FIG. 10 is a graph illustrating the XRD pattern of water-leached CS-7 residues which were heat-treated with NH₃ gas.

FIG. 11 is a photo of the LiOH·H₂O produced from the thermally reduced CS-7 by NH₃ gas.

FIG. 12 is the XRD pattern of the LiOH·H₂O product that is derived from the selective leaching of lithium from the heat-treated CS-7 at 550° C. using NH₃ gas.

### DETAILED DESCRIPTION

In this specification, when it is said that one component “includes” the other component, it means that another component is not excluded, and other components may be further included, unless explicitly stated otherwise.

In this specification, “A and/or B” means “A and B, or A or B”.

In this specification, a “lithium-ion battery” or “LIB” may include a waste lithium-ion battery and lithium-ion battery waste.

In this specification, the terms “waste lithium-ion battery”, “waste LIB”, “lithium-ion battery waste”, “LIB waste” refer to lithium-ion batteries that have reached the end of their useful lifespan. This may also refer to new lithium-ion batteries that have a charging capacity of 90% or less, preferably 50% or less, and more preferably 30% or less. Additionally, it includes cathode scraps (CS), which are waste materials generated during a battery manufacturing process, as well as lithium-ion battery cells discarded due to production defects that prevent their sale or distribution in the market.

The accompanying drawing in this specification illustrates embodiments of the present disclosure and, together with the description, explains its principles. However, the scope of the disclosure is not limited to these embodiments. The shape, size, scale, or ratio of an element in the drawings of this specification may be exaggerated to provide clearer explanations and should not be interpreted as limiting the invention.

Hereinafter, embodiments of the present disclosure are described in more detail.

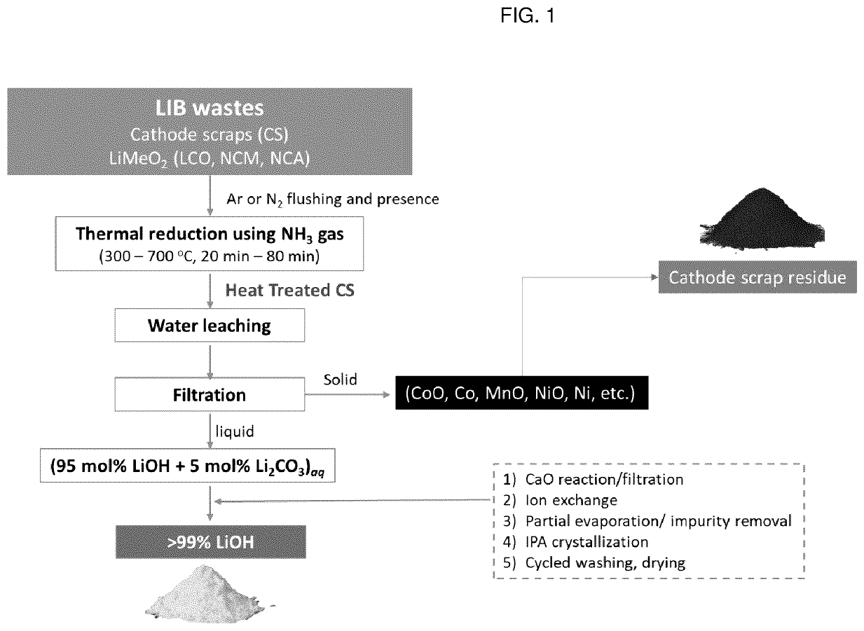

FIG. 1 is a schematic diagram illustrating the process of producing LiOH from LIB waste, specifically cathode scraps (CS), using NH₃ gas for thermal reduction. The process begins with CS having a general structure LiMeO₂ (where Me=Ni, Co, Mn, Al, or other transition metals, or combinations thereof). The cathode scraps undergo heat treatment in an NH₃ atmosphere, forming heat-treated CS. Following this, the process includes steps that selectively remove transition metal oxides (CoO, MnO, NiO, etc.) as CS residues, while lithium is extracted in the form of LiOH through water leaching. The final product is high-purity lithium hydroxide (LiOH or LiOH·H₂O) with purity greater than 99%. Each step is carefully outlined in FIG. 1 to show the transformation of the CS, recovery of lithium from the heat-treated CS and purification steps of the leached solution leading to the production of LiOH·H₂O, LiOH, or a combination of both.

The method of manufacturing lithium hydroxide from a lithium-ion battery, according to an embodiment of the present disclosure, relates to a thermo-chemical reduction method for a waste lithium-ion battery including active materials or cathode scraps using NH₃ gas as a reducing agent. This method effectively reduces the transition metals in the cathode materials to their lower oxidation states, or even to zero-valent transition metals and converts lithium to Li₂O. The method of invention achieves a high lithium leaching efficiency, exceeding 90%, with lithium that is selectively recovered as LiOH.

In an embodiment of the present disclosure, the method for producing LiOH from LIB waste involves heat-treating the waste, such as cathode scraps, at a temperature range of 400° C. to 700° C. in the presence of an anhydrous NH₃ gas. The method enables in-situ formation of Li₂O or LiOH during heat treatment. Accordingly, the LiOH is formed from the reaction between Li₂O and generated water vapor (H₂O). The generated Li₂O or LiOH can be selectively extracted through water leaching because the reduced transition metals (TMO or TM) remain undissolved in water.

The method of manufacturing LiOH from LIB waste, according to an embodiment of the present disclosure, relates to a method of separating water-leached LiOH from the solid residues, in which water-leached LiOH can be collected by performing a series of purification steps, including 1) magnetic separation, filtration, or centrifugation for solid/liquid separation, 2) a CaO reaction for the conversion of trace Li₂CO₃ into LiOH when a small fraction of Li₂CO₃ is present in the leachate, 3) an ion exchange process for the removal of other cations, i.e., a small quantity of contaminants, and 4) a series of evaporations-crystallization steps, which may or may not involve the use of isopropyl alcohol (IPA) as an anti-solvent, to obtain LiOH·H₂O product.

According to an embodiment of the present disclosure, the cathode scraps may have a common structure of LiMeO₂, where Me=Ni, Co, Mn, Al, or other transition metals, or combinations thereof. More specifically, the cathode scraps may have Chemical Formula 1.

LiCoₐMn_{b}Ni_{c}Al_{d}O₂ [Chemical Formula 1]
wherein each of a, b, c, and d is 0 or more and 1 or less, and if Li=1, a+b+c+d=1; if Li<1, 1<a+b+c+d<2; whereas if Li>1, 0<a+b+c+d<1.

Preferably, the cathode scraps may include one or more materials selected from the group consisting of lithium-nickel-manganese-cobalt oxide (NMC), lithium-nickel-cobalt-aluminum oxide (NCA), lithium-cobalt oxide (LCO), lithium-manganese oxide (LMO), and combinations thereof.

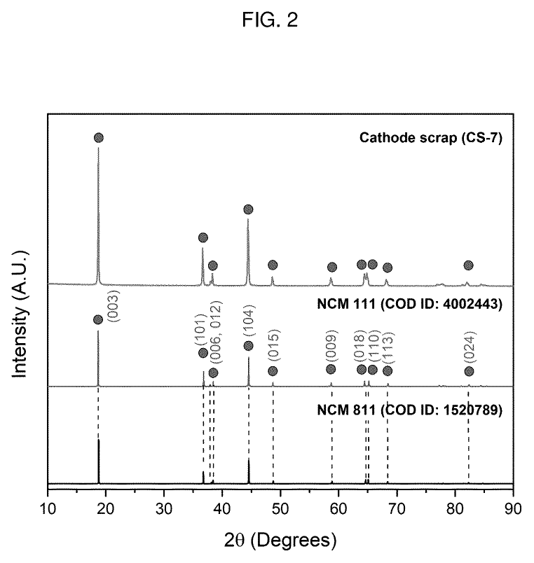

FIG. 2 is an XRD spectrum of cathode scraps (CS-7) as waste lithium-ion battery, which is confirmed as NMC. In this specification, “CS-7” means that it contains 7 wt % lithium.

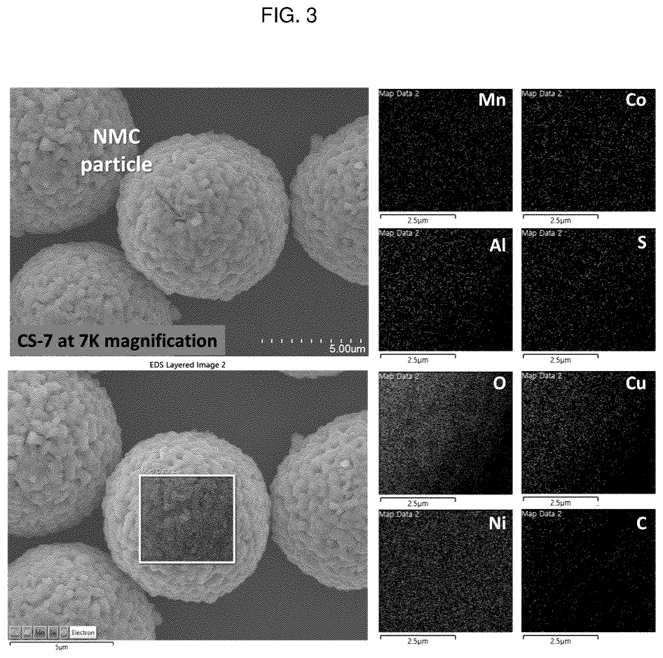

FIG. 3 shows the SEM-EDS images of the NMC cathode scrap CS-7, which reveals its spherical morphology with smaller polyhedral sub-units. The polyhedral structure within the larger spherical particles is typical in NMC cathode materials.

According to an embodiment of the present disclosure, the cathode scraps may include a different mole fraction of Ni, Co, Mn, Al, and other transition metals. The results on other types of battery chemical substances (LMO, LCO, and NCA) are described later.

According to an embodiment of the present disclosure, the cathode scraps may include 2 wt % to 7 wt % of lithium (Li), 0 wt % to 80 wt % of Ni, 0 wt % to 60 wt % of Co, 0 wt % to 20 wt % of Mn, or 0 wt % to 5 wt % of Al. A composition of the cathode scrap and associated properties thereof are listed in Table 1. Table 1 illustrates compositions and properties of CS-7 as a cathode scrap lithium-ion battery waste.

TABLE 1
Cathode scrap CS-7 composition and related properties.

| Components | Content (wt %) |
|---|---|
| Li | 7.29 ± 0.10 |
| B | 0.11 ± 0.01 |
| Na | 0.29 ± 0.05 |
| Al | 0.58 ± 0.01 |
| K | 0.21 ± 0.03 |
| Ca | 0.05 ± 0 |
| Mn | 3.49 ± 0 |
| Co | 2.64 ± 0.02 |
| Ni | 53.81 ± 0.3 |
| Zr | 0.2 ± 0.02 |
| Ba | 0.19 ± 0.01 |
| C | 0.13 ± 0.02 |
| H | 0 ± 0 |
| N | 0.01 ± 0.01 |
| S | 0.13 ± 0.01 |
| O | 16.7 ± 0.21 |
| Others | 14.70 |

| Other properties | Values |
|---|---|
| True density (r), g cm⁻³ | 3.56 ± 0.41 |
| Tap density, g cm⁻³ | 2.26 ± 0.004 |
| Bulk density, g cm⁻³ | 1.70 ± 0.003 |
| Moisture content (%) | 0.05 ± 0.007 |

According to an embodiment of the present disclosure, the cathode scraps may include 0 wt % to 5 wt % of Fe, 0 wt % to 5 wt % of Cu, and 0 wt % to 5 wt % of Al. The Cu may be included in an anode current collector. The Al may be included in a cathode current collector. It is preferable for Fe and Cu to be absent, as these reducible elements may compete with the desired reactions that consume the NH₃ reducing gas. It is also preferrable for Al to be absent, as formation of AlLiO₂, which is not soluble in water, may reduce % Li leaching efficiency.

According to an embodiment of the present disclosure, it is preferred that the cathode scraps contain less than 1% of carbon (C). It is preferred that the cathode scraps include minimum carbon because the leaching of lithium, which is in the form of LiOH, may be adversely affected. Low presence of carbon, that is, within the aforementioned range, minimizes the formation of carbon dioxide (CO₂) during thermo-chemical reduction because CO₂ readily reacts with Li₂O to form Li₂CO₃, as undesirable side product.

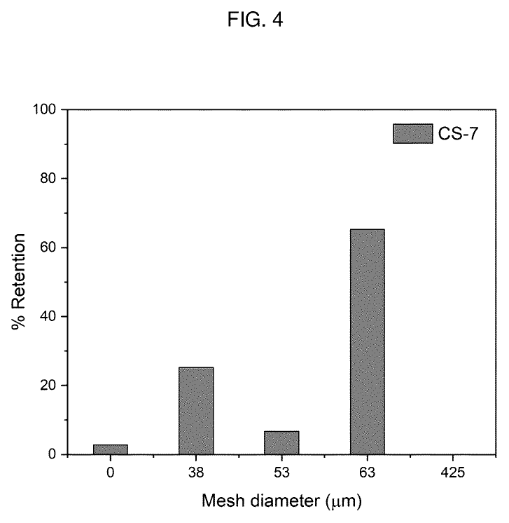

FIG. 4 is a graph illustrating the particle size distribution of cathode scrap CS-7 used in the present disclosure. According to an embodiment, as illustrated in FIG. 4, the cathode scraps may have a particle size of less than 200 μm, and more preferably, less than 75 μm. Cathode scraps with particle sizes in this range can undergo thermal reduction more efficiently due to their higher surface area, which enhances contact with the NH₃ gas, resulting in a shorter reaction time during the thermal reduction process.

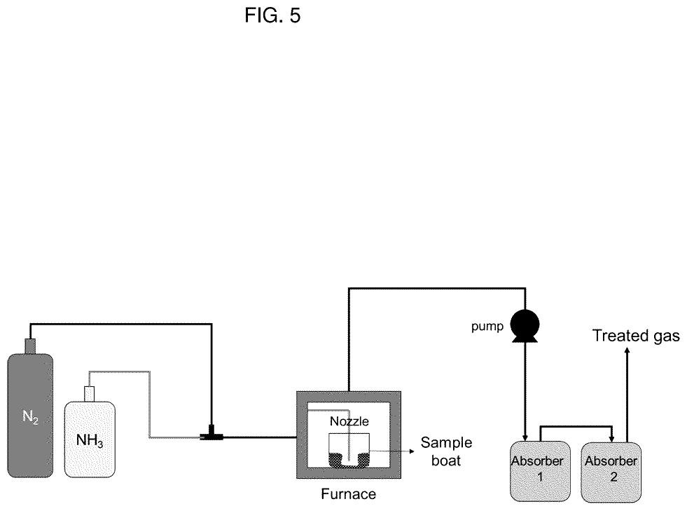

FIG. 5 is a diagram illustrating thermal reduction equipment for cathode scraps using NH₃ gas. According to an embodiment of the present disclosure, the thermal reduction of the cathode scraps requires equipment, such as that illustrated in FIG. 5. The equipment must be installed with an inert gas for Ar or N₂. The inert gas is necessary to purge air from the furnace prior to the heat treatment. It is essential that the furnace is perfectly sealed to prevent the inflow of air, as the presence of O₂ may compete with the desired reaction, reducing thermal reduction efficiency and lowering lithium leaching efficiency.

According to an embodiment of the present disclosure, the equipment may include a valve capable of locking an exit. Specifically, it is preferred that the exit is fixed with a one-way valve to prevent the inflow of gas from the outside of the furnace through the exit line because a slight pressure drop may occur within a chamber when the NH₃ gas reacts to the cathode scraps.

According to an embodiment of the present disclosure, the equipment may include a separate unit that supplies ammonia. Specifically, the equipment may have a separate gas line for anhydrous ammonia gas having minimum purity of 99%.

According to an embodiment of the present disclosure, the heat treatment for the reduction step in may be performed in a furnace capable of heating up to 1000° C.

According to an embodiment of the present disclosure, the furnace may have an entrance line having a nozzle capable of directly purging N₂ or NH₃ on the cathode scraps.

According to an embodiment of the present disclosure, the furnace may have a discharge gas line that is connected to an NH₃ absorption system including an acid solution. The acid solution effectively converts excess NH₃ gas into NH₄⁺ through an absorption-based capture mechanism. After this treatment, the processed gas exits the absorption system without being discharged into the environment.

According to an embodiment of the present disclosure, the method may include a preparation step by placing the cathode scraps in a ceramic boat followed by positioning the boat in the furnace.

According to an embodiment of the present disclosure, the heat treatment may be performed in a continuous mode using a rotary kiln equipped with feeding system at the inlet and a receiving system at the outlet of the tube.

According to an embodiment of the present disclosure, it is preferred that the rotary kiln is perfectly sealed to prevent the inflow of air and the leakage of ammonia gas during heat treatment.

According to an embodiment of the present disclosure, the reduction step may include heat-treating the cathode scraps for 20 minutes to 80 minutes at a final temperature of 300° C. to 700° C. Preferably, the thermal reduction step may include gradual heating of the furnace until it reaches the pre-determined final temperature of 500° C. to 600° C.

According to an embodiment of the present disclosure, the reduction step may include gradual heating of the furnace at a rate of 10° C.·min⁻¹ to 30° C.·min⁻¹.

According to an embodiment of the present disclosure, the thermal reduction may be performed for 20 minutes to 4 hours by continuously supplying the NH₃ gas depending on the mass of the cathode scraps or feeding rate in the continuously operated rotary kiln.

According to an embodiment of the present disclosure, the flow rate of the NH₃ gas may be 100 mL·min⁻¹ to 2 L·min⁻¹, depending on the mass of the cathode scraps or feeding rate in the continuously operated rotary kiln. According to an embodiment of the present disclosure, the NH₃ gas may be made to sufficiently come into contact with the cathode scraps by adjusting the flow rate of the ammonia gas in the aforementioned range during the thermal reduction step. Insufficient contact with the NH₃ gas may cause a decrease in reduction efficiency, particularly, resulting in loss of 20% to 40% in lithium leaching efficiency.

In one embodiment of the present disclosure, the amount of cathode scraps, estimated in moles, may serve as the basis for determining the required stoichiometric supply of NH₃ gas at the final reaction temperature. The total NH₃ gas requirement may be evenly supplied throughout the pre-determined operating time by adjusting NH₃ gas flow rate. The operation may be terminated once 1.2 equivalents of NH₃ gas have been supplied at the specified flow rate.

According to an embodiment of the present disclosure, upon termination of the thermal reduction of the cathode scraps, an inert gas may be supplied so that the cathode scraps are cooled until a temperature of less than 200° C. is reached. Unwanted oxidation can be prevented, and cooling can be rapidly implemented by shutting off the NH₃ gas supply and introducing the inert gas.

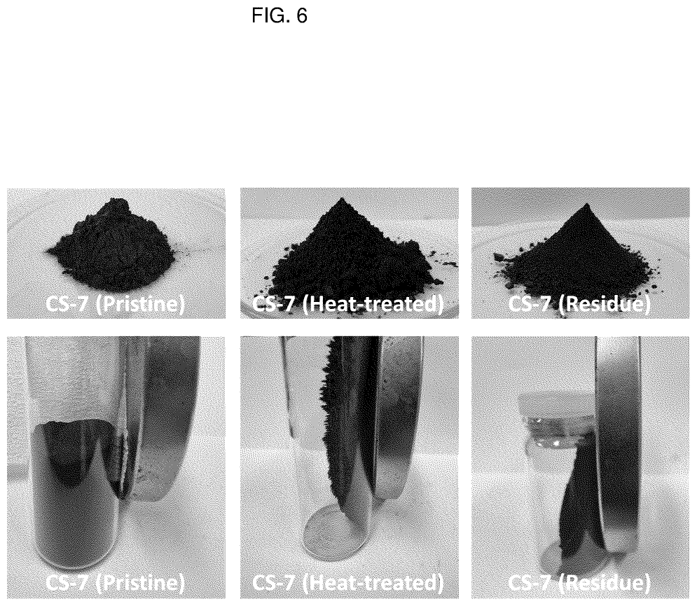

FIG. 6 shows the digital images of pristine CS-7, heat-treated CS-7, and CS-7 residues after water leaching. As transition metal oxides are reduced into low-valent oxide or zero-valent metal by the NH₃ gas, the heat-treated cathode scraps may exhibit magnetic properties in contrast to the pristine CS-7 due to the paramagnetism of zero-valent Co and Ni, and potential ferromagnetism of Fe, if present.

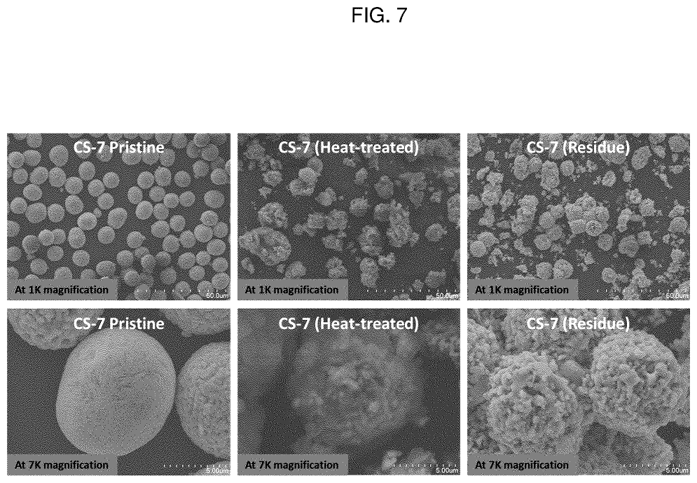

FIG. 7 is the SEM image of pristine CS-7, heat-treated CS-7, and CS-7 residues after water leaching. Compared to the pristine CS-7, the heat-treated CS-7 exhibited a highly disordered morphology. The well-defined structure of the pristine CS-7 undergoes decomposition and rupture, resulting in a less dense, more porous, irregular, and fragmented morphology of the heat-treated CS-7.

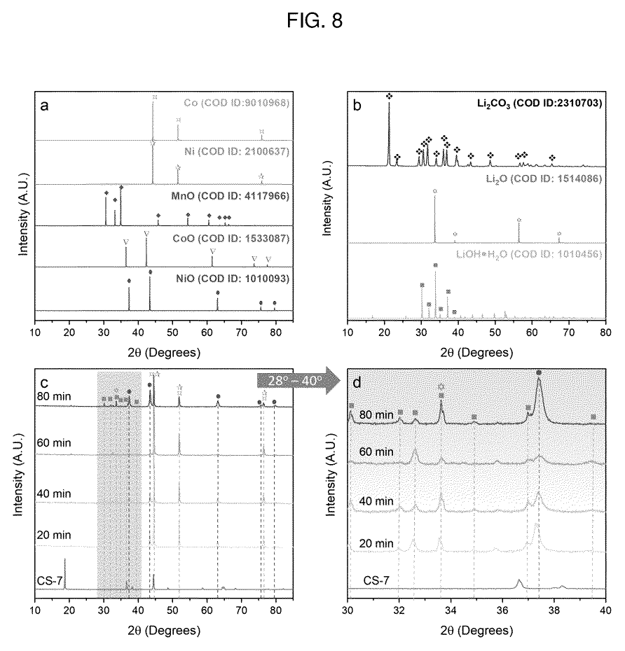

FIG. 8 presents the XRD spectrum of heat-treated CS-7 at 550° C. for different reaction times when the NH₃ gas is supplied (0.5 L·min⁻¹). The effectiveness of the reduction process by the NH₃ gas is further reflected in the XRD pattern of the heat-treated CS-7, which has undergone significant changes compared to pristine CS-7. The XRD pattern shows that major reduction products are metallic Co, Ni, and MnO, as shown by the reference patterns (FIGS. 8A and 8B).

To achieve complete reduction, the duration of the reduction step must be optimized. Insufficient reaction time (reduction time), despite sufficient NH₃ gas supply, results in incomplete reduction, as evidenced by the formation of low-valent NiO and CoO, which are observed in the XRD patterns of the CS-7 heat-treated for 20 to 40 minutes. Complete conversion to the zero-valent states of Ni and Co, along with the formation of low-valent MnO is achieved after 60 minutes. However, extending the reaction to 80 minutes leads to the reformation of low-valent NiO and CoO. Therefore, maintaining a delicate balance between the reaction time and NH₃ gas supply is crucial for an efficient thermal reduction process.

In the XRD pattern, the expected peaks for Li₂O are not distinctly observed. In contrast, clear peaks corresponding to LiOH·H₂O are easily detected. This suggests an in-situ conversion of Li₂O into LiOH·H₂O, which is reasonable conversion, considering the unavoidable generation of water vapor as a by-product of the reduction process. The vapor likely accelerates the hydration of Li₂O, leading to the formation of LiOH·H₂O within the structure of the heat-treated CS-7.

TABLE 2
Thermo-reduction results of CS-7 using NH₃ gas.
Feed mass (m_{cs}), g) 5.10 Treated mass (m_{CSHT}), g 4.30
% Feed mass recovery 84.31

| | | Heat-treated | |
|---|---|---|---|
| i = Li, Ba, | CS-7 composition | Composition | |
| Na, Al, etc. | (xᵢ), wt % | (xᵢ^{HT}), wt % | % retention_i |
| Li | 7.29 ± 0.10 | 8.58 ± 0.14 | 99.23 ± 1.56 |
| Na | 0.29 ± 0.05 | 0.35 ± 0.02 | 100.3 ± 3.32 |
| Al | 0.58 ± 0.01 | 0.66 ± 0.04 | 95.94 ± 6.29 |
| K | 0.21 ± 0.03 | 0.22 ± 0.02 | 88.32 ± 10.31 |
| Ca | 0.05 ± 0 | 0.03 ± 61 | 50.58 ± 0.20 |
| Mn | 3.49 ± 0 | 3.46 ± 0.25 | 85.63 ± 6.07 |
| Co | 2.64 ± 0.02 | 2.68 ± 0.2 | 84.17 ± 6.15 |
| Ni | 53.81 ± 0.3 | 49.63 ± 2.48 | 88.07 ± 4.39 |
| Ba | 0.19 ± 0.01 | 0.18 ± 0 | 100.00 ± 7.28 |

Table 2 illustrates the results of thermal reduction of CS-7 using NH₃ gas. After the heat treatment, it is expected that the mass of the CS-7 will be reduced because oxygen (O) is removed from the transition metal oxide, but hydration of Li₂O to LiOH·H₂O partially increases the mass of the sample. Thus, the total decrease in the mass of CS-7 did not exceed 20% as illustrated in Table 2.

Considering that the thermo-chemical reduction of the cathode scraps is performed at temperatures below 700° C., it is expected that the mass of the elements of interest (i=Li, Ni, Co, or Mn) will remain unchanged before (m_{CS-i}) and after the heat treatment (M_{CSHT-i}) as represented in Equation 1. The amount of elements of interests (m_{CS-i}) may be calculated by multiplying the mass fraction of element i(xᵢ) in the pristine CS-7 with the mass of the pristine cathode scrap CS-7 (m_{CS}). In contrast, m_{CSHT-i} is calculated from the mass fraction of the element i(xᵢ^{HT}) multiplied with the mass of the heat-treated cathode scrap CS-7 (m_{CSHT}).

$${m}_{CS - i} = {m}_{CSHT - i} ; {m}_{CS} \times {x}_{i} = {m}_{CSHT} \times {x}_{i}^{HT} \qquad [ Equation 1 ]$$

The mass conservation of the element before and after the heat treatment may be calculated using Equation 2. The conversion is represented as the term of % retention of the element i (% retention_i).

$$\% {retention}_{i} = \frac{{m}_{CSHT - i}}{{m}_{CS - i}} \times 100 = \frac{{m}_{CSHT} \times {x}_{i}^{HT}}{{m}_{CS} \times {x}_{i}} \times 100 \qquad [ Equation 2 ]$$

Table 2 summarizes the elemental composition of CS-7 before and after heat treatment. Some elements exhibited lower than expected masses after thermal reduction (i.e., 50 to 88% retention), which can be associated with the heterogeneity of the heat-treated CS-7 because the reduced transition metal tends to form clusters. The observed discrepancy is due to the non-uniform distribution of elements in the representative samples for analysis.

According to an embodiment of the present disclosure, the method may include a purging step (S5) of the furnace by using the inert gas prior to the reduction step.

According to an embodiment of the present disclosure, the purging step (S5) supplying the inert gas to the furnace at a flow rate of 0.5 L·min⁻¹ to 2 L·min⁻¹, with the purging duration adjustable based on the furnace volume.

According to an embodiment of the present disclosure, the flow rate in the purging step (S5) may be adjusted to reach the purging within less than 30 minutes.

According to an embodiment of the present disclosure, the cathode scraps after the purging step (S5) may be gradually heated at a rate of 10° C.·min⁻¹ to 30° C.·min⁻¹ to commence the thermal reduction step (S10). Specifically, the supply of NH₃ gas begins once the temperature reaches 100° C., and the system is gradually heated to facilitate efficient thermal reduction. The reduction commences once the predetermined temperature of 300° C. to 700° C. is reached, preferably 500° C. to 600° C., and is maintained for an optimized duration to complete the reduction.

According to an embodiment of the present disclosure, the method includes a leaching step (S20) to recover lithium that is present in the heat-treated cathode scraps using water.

According to an embodiment of the present disclosure, the heat-treated cathode scraps should not be exposed to air, which typically contains 421 ppmᵥ CO₂. This precaution prevents CO₂ from reacting with the lithium in the heat-treated cathode scrap and forming Li₂CO₃, which is a contaminant in the LiOH production.

According to an embodiment of the present disclosure, the water leaching process may include the use of deionized water that is not exposed to the air, water purged by N₂, or a combination thereof. Carbon dioxide can be prevented from being absorbed in the leached solution and the contaminant CO₃²⁻ can be prevented from being formed.

According to an embodiment of the present disclosure, the leaching step (S20) may be performed at a solid/liquid (S/L) ratio of 125 to 300 g L⁻¹ at room temperature. Specifically, the leaching step (S20) may be performed at room temperature (25° C.) and at a solid/liquid (S/L) ratio of 125 to 300. The presence of OH in the heat-treated cathode scraps results in a highly alkaline (pH=12-12.8) leached solution due to high solubility of LiOH in water. With LiOH being more significantly soluble in water (216 g L⁻¹ at 20° C.) than Li₂CO₃ (12.9 g L⁻¹ at 25° C.), LiOH can be easily extracted by water leaching than Li₂CO₃. As a result, LiOH extraction could reduce water consumption by 15 times as much larger amount of LiOH can dissolve in water than Li₂CO₃.

According to an embodiment of the present disclosure, the leaching step (S20) may be performed from one to ten times of washing. Specifically, the leaching step (S20) may be performed by washing the heat-treated cathode scrap from two to three times. The resulting lithium efficiency can be maximized by adjusting the number of washes performed for the heat-treated cathode scrap during the leaching step.

According to an embodiment of the present disclosure, the first wash leached solution can be reused several times to wash fresh heat-treated cathode scrap several times. As the number of reuses increase, the amount of LiOH dissolved in the first wash leached solution also increases. This approach maximizes the amount of LiOH dissolved in the first wash solution, thereby increasing the LiOH concentration. Specifically, the first wash leached solution can be reused three to five times to achieve a nearly saturated LiOH solution. A higher LiOH concentration in the leached solution significantly reduces the leached solution volume that requires treatment for the subsequent purification, evaporation and crystallization/precipitation steps.

According to an embodiment of the present disclosure, the leaching step (S20) may include agitating or mixing the heat-treated cathode scrap and water from 200 rpm to 1000 rpm. Specifically, the leaching step (S20) may include agitating or mixing the heat-treated cathode scraps and water at 400 rpm. The leaching efficiency can be maximized by adjusting the stirring and mixing rates in the leaching step as described above.

According to an embodiment of the present disclosure, the leaching step (S20) may be performed for 10 minutes to 1 hour. Specifically, the leaching step (S20) may be performed for 30 minutes.

According to an embodiment of the present disclosure, a solid/liquid separator—such as a centrifuge, membrane filter, or any other equipment that serves the same purpose-may be used in the separation step (S30) of the solid residue and leached solution.

According to an embodiment of the present disclosure, the method may include a filtration step (S30) to separate the solid residues from the leached solution after the leaching step (S20).

According to an embodiment of the present disclosure, after the leaching step (S20), magnetic separation may be performed. Magnetic separation is performed for solid/liquid separation step (S30) after the lithium leaching step (S20). The water-leached solid residues may be retrieved with the help of gravity or a magnet. However, considering that the heat-treated cathode scraps frequently have magnetism, it is not appropriate to use magnetic stirring in the leaching step for lithium recovery.

According to an embodiment of the present disclosure, after any solid/liquid separation step, the supernatant may be further purified by a second purification step such as membrane filtration to remove fine particle residues, if present, in the leached solution.

Leaching efficiency of the element i (% Leaching_ᵢ) from the heat-treated cathode scraps may be calculated according to Equation 3 or Equation 4. The mᵢ^{L} is the mass of the leached element i and may be directly measured from the leached solution having a concentration (Cᵢ) and volume (V_{L}) or may be estimated from the difference between M_{CSHT-1} and mᵢ^{R} as expressed in Equation 5. Furthermore, the mᵢ^{R} is the remaining mass of the element i in the solid cathode scrap collected after leaching step (S20). The mᵢ^{R} can be estimated from the remaining mass m^{R}_{CSHT} of the cathode scrap collected after leaching step (S20) having a mass fraction of element i (xᵢ^{R}).

A percent leaching selectivity (αᵢ) of element i can be calculated according to Equation 6 based on the ratio of mᵢ^{L′} (in terms of moles) and the total of moles of leached elements. The mᵢ^{L′} can be estimated given atomic mass (At._massᵢ) of each element in the leached solution: Li=6.941, Ni=58.693, Co=58.933, Mn=54.938, Al=26.982, Fe=55.845, Cu=65.546, Ca=40.078, Na=22.989, K=39.098, and so forth.

$$\% {Leaching}_{\_ i} = \frac{{m}_{i}^{L}}{{m}_{CSHT - i}} \times 100 \% = \frac{{C}_{i} {V}_{L}}{{m}_{CSHT - i}} \times 100 \% = \frac{( {m}_{CSHT - i} - {m}_{i}^{R} )}{{m}_{CSHT - i}} \times 100 \% ; \qquad [ Equation 3 ]$$

$$\% {Leaching}_{\_ i} = \frac{( {m}_{CSHT} \times {x}_{i}^{HT} - {m}_{CSHT}^{R} \times {x}_{i}^{R} )}{{m}_{CSHT} \times {x}_{i}^{HT}} \times 100 \% \qquad [ Equation 4 ]$$

$${m}_{i}^{R} = {m}_{CSHT}^{R} \times {x}_{i}^{R} \qquad [ Equation 5 ]$$

$${α}_{i} = \frac{{m}_{i}^{{L}^{′}}}{\sum {m}_{i}^{{L}^{′}}} \times 100 \% = \frac{( {m}_{CSHT} \times {x}_{i}^{HT} - {m}_{CSHT}^{R} \times {x}_{i}^{R} ) / At . {\_mass}_{i}}{\sum {m}_{i}^{{L}^{′}}} \times 100 \% \qquad [ Equation 6 ]$$

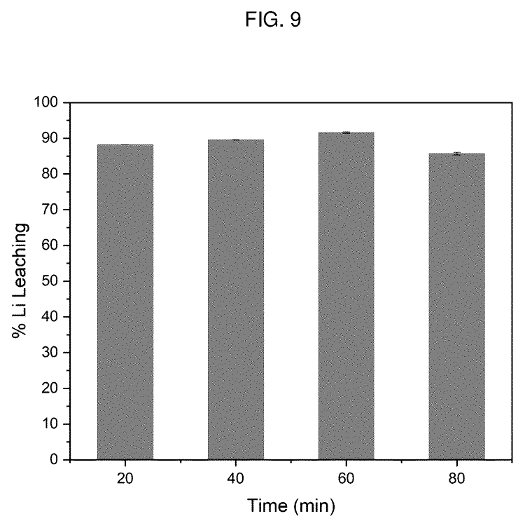

FIG. 9 illustrates the leaching efficiency of lithium using water from the heat-treated CS-7 at different reaction times. The lithium leaching efficiencies are in the range of 88% to 93% for CS-7 heat-treated by the NH₃ gas. Results from the highest leaching efficiency at 60 minutes reduction duration are listed in Table 3.

TABLE 3
Water leaching results for lithium from CS-7 heat-treated with NH₃ gas for 60 mins.

| | | Cᵢ (mg/L) V_{L} = 20 | | mi^{L} | | | | |
|---|---|---|---|---|---|---|---|---|
| | m_{CSHT}_{_{—}}ᵢ | mL mL | mi^{L} | (2^{nd} and 3^{rd} | | | | |
| CS-7 | (m_{CSHT} = 3.20 g) | (1^{st} wash) | (1^{st} wash) | washes) | mi^{L} a total | mi^{R} (mg) | % Leaching | aᵢ |
| Li | 208.7 ± 3.64 | 8,804.5 ± 3.54 | 176.09 ± 0.07 | 15.51 ± 3.68 | 191.6 ± 3.61 | 17.1 ± 0.03 | 91.81 ± 0.13 | 97.55 |
| Na | 17.68 ± 0.62 | 240.5 ± 14.35 | 4.81 ± 0.94 | 0 ± 0 | 4.81 ± 0.65 | 12.87 ± 0.03 | 27.11 ± 4.35 | 2.45 |
| Al | 26.09 ± 0.23 | 0 ± 0 | 0 ± 0 | 0 ± 0 | 0 ± 0 | 26.09 ± 0.23 | 0 ± 0 | 0 ± 0 |
| K | 6.74 ± 0.19 | 0 ± 0 | 0 ± 0 | 0 ± 0 | 0 ± 0 | 6.74 ± 0.19 | 0 ± 0 | 0 ± 0 |
| Ca | 0 ± 0 | 0 ± 0 | 0 ± 0 | 0 ± 0 | 0 ± 0 | 0 ± 0 | 0 ± 0 | 0 ± 0 |
| Mr | 130.58 ± 0.37 | 0 ± 0 | 0 ± 0 | 0 ± 0 | 0 ± 0 | 130.58 ± 0.37 | 0 ± 0 | 0 ± 0 |
| Co | 101.94 ± 0.89 | 0 ± 0 | 0 ± 0 | 0 ± 0 | 0 ± 0 | 101.94 ± 0.89 | 0 ± 0 | 0 ± 0 |
| Ni | 1854.39 ± 0.83 | 0 ± 0 | 0 ± 0 | 0 ± 0 | 0 ± 0 | 1,854.39 ± 0.83 | 0 ± 0 | 0 ± 0 |
| Ba | 5.03 ± 0.06 | 0 ± 0 | 0 ± 0 | 0 ± 0 | 0 ± 0 | 5.03 ± 0.06 | 0 ± 0 | 0 ± 0 |

When the leaching is performed at S/L ratio of 160 for 30 minutes, the 1^{st} wash solution contained 8,804 mg·L⁻¹ of lithium. Furthermore, it was confirmed that the extracted lithium is in LiOH form rather than Li₂CO₃ because the elution of Li₂CO₃ could never exceed its lithium saturation point of 2,430 mg·L⁻¹ due to the limited solubility of Li₂CO₃ in water. During the 1^{st} wash (1^{st} leaching), 84.33% of lithium was already effectively eluted. The remaining elutable lithium of 4 to 10% was extracted during the 2^{nd} and 3^{rd} washes (elution) by using the same leaching conditions. Generally, the leaching step using water may be performed within 3 hours, including solid/liquid separation. After the leaching step, the total lithium leaching efficiency was 92%. Only Na was eluted along with lithium, and a total lithium leaching selectivity (α_{Li}) of 97% or more was obtained.

The reduction of other types of cathode materials, such as LiCoO₂(LCO) and Li(Ni_{0.80}Co_{0.15}Al_{0.05})O₂(NCA), using NH₃ gas was also carried out. The % lithium leaching efficiencies of 77 to 91% and % Li leaching selectivity α=100% were achieved as listed in Table 4.

TABLE 4
Water leaching results for lithium from LCO and NCA cathode materials heat-treated with NH₃ gas for 60 mins.

| | | Cᵢ (mg/L) | | mi^{L} | | | | |
|---|---|---|---|---|---|---|---|---|
| | m_{CSHT}_{_{—}}ᵢ | V_{L} = 8 mL | mi^{L} | (2^{nd} and 3^{rd} | | | | |
| LCO | (m_{CSHT} = 1.20 g) | (1^{st} wash) | (1^{st} wash) | wash) | mi^{L} total | mi^{R} (mg) | % Leaching | aᵢ |
| Li | 85.45 ± 1.52 | 7,008 ± 31.11 | 56.06 ± 0.25 | 9.5 ± 2.97 | 65.57 ± 2.72 | 19.88 ± 4.25 | 76.78 ± 4.6 | 100 |
| Co | 694.51 ± 5.77 | 0 ± 0 | 0 ± 0 | 0 ± 0 | 0 ± 0 | 694.51 ± 5.77 | 0 ± 0 | 0 ± 0 |

| | | Cᵢ (mg/L) | | mi^{L} | | | | |
|---|---|---|---|---|---|---|---|---|
| | m_{CSHT}_{_{—}}ᵢ | V_{L} = 8 mL | mi^{L} | (2^{nd}-3^{rd} | | | | |
| NCA | (m_{CSHT} = 1.20 g) | (1^{st} wash) | (1^{st} wash) | wash) | mi^{L} total | mi^{R} (mg) | % Leaching | aᵢ |
| Li | 79.45 ± 0.76 | 7,543.5 ± 54.45 | 60.35 ± 0.44 | 12.28 ± 1.32 | 72.63 ± 0.89 | 6.82 ± 0.13 | 91.41 ± 0.2 | 100 |
| Al | 10.55 ± 0.11 | 0 ± 0 | 0 ± 0 | 0 ± 0 | 0 ± 0 | 10.55 ± 0.11 | 0 ± 0 | 0 ± 0 |
| Mn | 20.12 ± 0.13 | 0 ± 0 | 0 ± 0 | 0 ± 0 | 0 ± 0 | 20.12 ± 0.13 | 0 ± 0 | 0 ± 0 |
| Co | 96.05 ± 2.36 | 0 ± 0 | 0 ± 0 | 0 ± 0 | 0 ± 0 | 96.05 ± 2.36 | 0 ± 0 | 0 ± 0 |
| Ni | 612.28 ± 1.68 | 0 ± 0 | 0 ± 0 | 0 ± 0 | 0 ± 0 | 612.28 ± 1.68 | 0 ± 0 | 0 ± 0 |

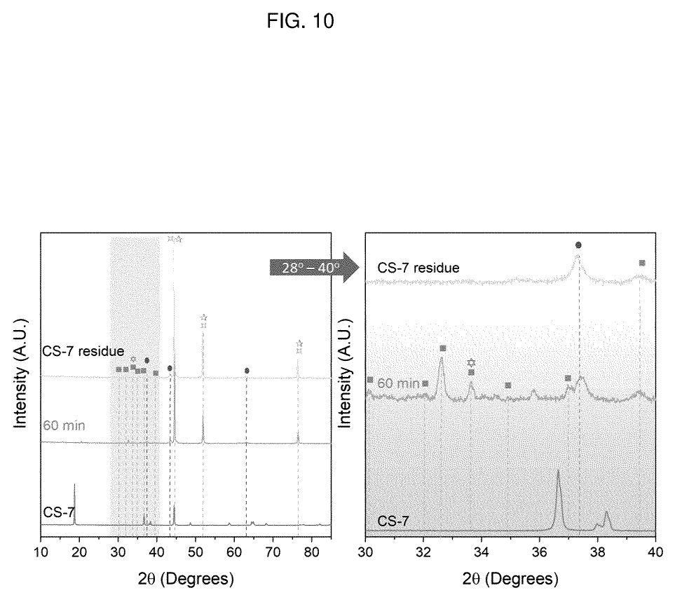

FIG. 10 illustrates an XRD pattern of the heat-treated CS-7 residues which were collected after water leaching. The XRD pattern of the heat-treated CS-7 residues shows that the peaks associated with lithium hydroxide disappeared, confirming its successful extraction through water leaching. The XRD pattern also shows that the sharp peaks corresponding to the reduced metal (low-valent or zero-valent states) were retained because these reduced metals were not dissolved in water. The solid residues retain magnetism due to the reduced transition metals remaining in their zero-valent states. Moreover, FIG. 7 shows the SEM image of the CS-7 residue after water leaching, revealing a rougher structure and more defined grains as a result of lithium extraction during the water leaching step.

According to an embodiment of the present disclosure, the water-leached solution may contain carbonate ions (CO₃²⁻). Specifically, the water-leached solution may include less than 5 mol % of CO₃²⁻ ions. Table 5 presents the concentration of anions (CO₃²⁻ and OH) in the leached solution. It is preferred to minimize the CO₃²⁻ ions content by preventing the leached solution being exposed to the atmosphere.

According to an embodiment of the present disclosure, the water-leached solution may include between 95 mol % and 100 mol % of hydroxide ions (OH⁻), with CO₃²⁻ present in amounts less than 5 mol %. By carefully controlling the water leaching process of the heat-treated cathode scraps (CS-7) and preventing exposure to atmospheric CO₂, it is possible to minimize or eliminate the formation of carbonate ions, resulting in a predominantly hydroxide ion composition.

TABLE 5
Anions (CO₃²⁻ and OH⁻) in the leached solution.

| | Li | | CO₃²⁻ | OH⁻ | mol % | mol % |
|---|---|---|---|---|---|---|
| LIB waste | (mg · L⁻¹) | pH | (mg · L⁻¹) | (mg · L⁻¹) | CO₃²⁻ | OH⁻ |
| CS-7 | 8,804 ± 6.54 | 12.15 ± 0.01 | 4,222 ± 104 | 22,827 ± 201 | 4.98 | 95.02 |
| CS-7 | 7,327 ± 114.55 | 12.24 ± 0 | 0 ± 0 | 20,378 ± 26 | 0.00 | 100.00 |
| CS-7 | 11,530 ± 226.27 | 12.02 ± 0.01 | 1,327 ± 18 | 32,598 ± 192 | 1.14 | 98.86 |
| LCO | 7,008 ± 31.11 | 12.16 ± 0.06 | 1,424 ± 49 | 19,401 ± 40 | 2.04 | 97.96 |
| NCA | 7,543 ± 54.45 | 12.07 ± 0.02 | 2,389 ± 22 | 20,584 ± 141 | 3.18 | 96.82 |

According to an embodiment of the present disclosure, the method may include a CaO addition and precipitate removal step (S40), in which CaO is added to the filtered leached solution (S30), and the resulting precipitates from CaO reaction are removed. During CaO addition in the filtered leached solution, the trace CO₃²⁻ present in the LiOH leached solution can be removed by forming CaCO₃ precipitates by reacting with the small amount of CaO or Ca(OH)₂ added.

According to an embodiment of the present disclosure, after the solid/liquid separation step (S30), Ca(OH)₂ may be added instead of CaO or a mixture of CaO and Ca(OH)₂ may be added.

According to an embodiment of the present disclosure, it is preferred that CaO, Ca(OH)₂, or a mixture thereof, added after the filtration step (S30), be used in 1.2 equivalents relative to the CO₃²⁻ ions present in the leached solution.

According to an embodiment of the present disclosure, the method may include an ion exchange step (S50), in which the solution, after the CaO addition and precipitate removal step (S40), is passed through the ion exchange resin bed. In this step, small amounts of metal contaminants and the incidental leaching of various metal ions including Al, Fe, Ni, Co, Ca, and Mn can be achieved.

In one embodiment, the ion exchange resin may be cation exchange resin, such as Amberjet 1500H, Amberlite IRC-747, or IRC-748, all of which are commercially available. It is preferred that the ion exchange resin is pre-washed prior to its use by using deionized water, then treated with HCl, and finally balanced by the LiOH solution with similar concentration of the leached solution. This process minimizes Li loss during ion exchange step.

According to an embodiment of the present disclosure, the method may include an evaporation step (S60), which involves removing impurities by evaporating a portion of the solution following the ion exchange step (S50). This step helps prevent boron contamination when using a stainless-steel reactor or prevent silica contamination when using a glass reactor. The evaporation process can be connected to a distillation device capable of operating under vacuum or non-vacuum conditions to collect water for reuse.

According to an embodiment of the present disclosure, the temperature in the evaporation step (S60) may range from 40° C. to 120° C. Specifically, the reactor temperature may be maintained at a temperature to maintain the evaporation of water with or without vacuum. However, it is preferred that the temperature is raised to an appropriate temperature that would accelerate the evaporation rate.

According to an embodiment of the present disclosure, the solution may be cooled when its volume is reduced to near LiOH solution saturation point during the evaporation step (S60). Specifically, when the bulk of the solution is reduced in the evaporation step (S60), the solution may be cooled using a cooler. As the cooling process proceeds, re-crystallization of the remaining impurities like CaCO₃ may occur. The crystallized pollutants may be separated through decantation in a separate reactor.

According to an embodiment of the present disclosure, the method may further include a solvent crystallization step (S70) to crystallize the LiOH after impurities are removed by adding isopropyl alcohol (IPA) after the evaporation step (S60). This step helps agglomerate LiOH, LiOH·H₂O or a combination of both crystals, and through repeated washing with isopropyl alcohol (IPA), further removes impurities and purifies the product. As a result, high-purity LiOH·H₂O or LiOH crystals or a combination of both having high purity, that is, purity of more than 99%, can be obtained.

According to an embodiment of the present disclosure, the method may also involve heating the solution until it is fully dried.

According to an embodiment of the present disclosure, the method may further include a wash step after the crystallization step (S70).

According to an embodiment of the present disclosure, the crystallization step (S70) and the wash step may be repeated to achieve high purity LiOH·H₂O crystals. Specifically, it is important to check the water content during the solvent crystallization step, that is, during IPA addition step and washing step. The water content must be maintained less than 5 wt %. When the water content is greater than 5 wt %, LiOH may be significantly lost, reducing the product yield. Accordingly, it is essential to pay close attention to the water content during solvent crystallization S70 and washing step to ensure high LiOH·H₂O product yield.

According to an embodiment of the present disclosure, a precise crystallization step (S70) may employ a device as an alternative method to IPA addition (solvent crystallization) to achieve high purity LiOH·H₂O. Specifically, the crystallization device may be an evaporative crystallization device, which offers advantageous in monitoring saturation, optimizing the cooling profile, and particle size and purity of the LiOH·H₂O crystals.

According to an embodiment of the present disclosure, the crystallization device may typically include characteristics, such as circulation zone to promote uniform supersaturation, nucleation zones for initiating crystal formation, and a growth chamber to allow crystals to grow to a predetermined size without agglomeration.

According to an embodiment of the present disclosure, the crystallization device may be designed along with a baffle system or an ultrasonic probe to control the distribution of crystal sizes.

According to an embodiment of the present disclosure, to separate LiOH·H₂O, the crystallization device may be fitted with a cooling system that gradually lowers a temperature to achieve supersaturation without adversely affecting the solution. This controlled environment helps minimize the inclusion of impurities and ensures that the LiOH·H₂O remains uncontaminated.

According to an embodiment of the present disclosure, crystallization step (S70) can be carried out using crystallizers with industry-standard designs, such as devices such as draft tube baffled (DTB) crystallizer, forced circulating crystallizer (FCC), Oslo crystallizer, or other devices serving the same purpose.

According to an embodiment of the present disclosure, once the crystallization process is complete, the crystals may be separated from the mother liquor using a solid/liquid separation system integrated with the crystallization device. Subsequent wash using IPA can purify a product and remove residual substances, preventing the loss of LiOH and producing LiOH·H₂O crystals with a purity exceeding 99%.

According to an embodiment of the present disclosure, the solid/liquid separation system integrated with the crystallization device can be a centrifuge, a membrane filtration system or other device serving the same purpose.

Hereinafter, examples of the present disclosure are provided in detail to illustrate specific embodiments. However, these examples may be modified in various other forms, and the scope of the present disclosure should not be limited to the examples described hereinafter. The examples are intended to assist those skilled in the art in fully understanding the present disclosure.

### EXAMPLES

### 1. Thermal-Chemical Reduction Step of CS-7 Using NH₃ Gas

(1) CS-7 having the composition listed in Table 1 was used as a feedstock for thermal reduction. About 1 g to 10 g of the CS-7 was placed in a ceramic crucible. Thereafter, the CS-7 was placed in a muffle furnace with a chamber capacity of 3 L.

The furnace was purged with N₂ gas at a flow rate of 2 L·min⁻¹ for about 5 to 10 minutes. After the N₂ gas supply was stopped, the furnace was programmed to heat from room temperature to 550° C. at a rate of 20° C.·min⁻¹, with a holding time of 20 minutes.

The NH₃ gas was supplied at 0.5 L·min⁻¹ at 100° C. and continued until the furnace heating program ended. The furnace was then cooled by flushing with N₂ gas at a flow rate of 2 L·min⁻¹ until the temperature dropped to 300° C. The furnace was then naturally cooled, taking about 2 hours to reach a temperature below 100° C. Thereafter, the sample was promptly covered and removed from the furnace. The thermal reduction process showed the results of lithium leaching efficiency of 88% with the lithium leaching selectivity of 95%.

(2) 1 kg of the CS-7 was introduced using an automatic feeding system in a rotary kiln.

Prior to CS-7 addition, a 2-meter stainless steel tube (volume: 27 L) was evacuated using a vacuum pump and then purged twice with N₂ gas. The CS-7 was supplied at a rate of 10 g·min⁻¹ while maintaining a rotary kiln temperature of at 550° C.

The ammonia gas was supplied at a rate of 3 L·min⁻¹. The entire operation lasted for 2 hours, with 1 hour allocated for the thermal reduction. About 892 g of thermally reduced CS-7 was collected. Lithium leaching efficiency was recorded as 92.3% with lithium leaching selectivity of 94.33%.

### 2. Water Leaching (BMHT) of Heat-Treated Cathode Scrap CS-7

### (1) Single Feed Supply Method

In the examples 1-(1) and 1-(2), the heat-treated CS-7 was added with N₂-purged deionized water at S/L ratios 100, 125, and 150.

At an S/L ratio of 100, 4.2 g of the heat-treated CS-7 was added to 40 mL of N₂-purged deionized water. The 1^{st} wash leached solution resulted in a Li concentration of 5,726 mg·L⁻¹, a CO₃²⁻ concentration of 1,828 mg·L⁻¹, and a OH concentration of 15,809 mg·L⁻¹, with a pH of 12.33.

At an S/L ratio of 125, 3.1 g of the heat-treated CS-7 was leached by 24 mL of N₂-purged deionized water. The 1^{st} wash leached solution resulted in a Li concentration of 7,331 mg·L⁻¹, a CO₃²⁻ concentration of 1,231 mg·L⁻¹, and a OH concentration of 20,707 mg·L⁻¹, with a pH of 12.57.

At an S/L ratio of 150, 3.2 g of the heat-treated CS-7 was added to 20 ml of water. The 1^{st} wash leached solution resulted in a Li concentration of 8,712 mg·L⁻¹, a CO₃²⁻ concentration of 4,222 mg·L⁻¹, and a OH concentration of 22,827 mg·L⁻¹, with a pH of 12.59.

Total lithium leaching efficiencies of examples in single feed supply method were from 90.7% to 91.6% after three washes.

### (2) Multi-Feed Supply Method

In examples 1-(1) and 1-(2), the heat-treated CS-7 was added to N₂-purged deionized water at an S/L ratio of 143. About 70 mL of N₂-purged deionized water was added with 10 g of the heat-treated CS-7.

After the first leaching, the residues were separated through centrifugation or vacuum filtration. Thereafter, the leached solution was collected. Thereafter, a new CS-7 (10 g) was added further to the filtered leached solution as a second batch. These steps were repeated three times (i.e., three batches of heat-treated CS-7 were first washed (1^{st} wash) in the same leached solution).

After the 1^{st} wash of three batches (30 g total) of heat-treated CS-7, the total amount of water used was 80 mL, equivalent to S/L ratio of 500. After the first wash of 10 g of the CS-7, lithium concentration was 7,327 mg·L⁻¹. After the second batch of the CS-7 was washed in the same leached solution, the lithium concentration increased to 14,912 mg·L⁻¹. Thereafter, after a third batch of the CS-7 was washed, the final lithium concentration was 21,200 mg·L⁻¹.

After the first wash of 30 g heat-treated CS-7, the combined three batches of CS-7 was further washed two times using the similar volume of N₂-purged deionized water (i.e., 70 mL of fresh N₂-purged deionized water for the 2^{nd} wash and 70 mL of fresh N₂₋ purged deionized water for the 3^{rd} wash).

The total % lithium leaching efficiency of 30 g of the CS-7 using 70 ml of deionized water per wash three times was 91%. After the three batches of leaching the heat-treated CS-7, the final solution from the 1^{st} wash (80 mL) had a pH of 12.6, an OH⁻ concentration of 58,478 mg·L⁻¹, and no detectable CO₃²⁻.

### 3. LiOH Purification and Crystallization

(1) The collection of LiOH was performed on the representative leached solutions described in the methods 2-(1) and 2-(2).

150 mg of CaO (1.3 equivalent) was added to 100 ml of the leached solution including 7,331 mg·L⁻¹ of lithium. The reaction was carried out at room temperature for 6 hours, with continuous shaking at 300 rpm.

The leached solution, to which the CaO was added, was then filtered to separate CaCO₃ precipitates.

Thereafter, the filtered substance passed through 20 g of Amberjet 1500H resin for 12 hours.

The collected effluent was pre-concentrated by reducing the volume of the filtered leachate solution to 50 mL. The solution was then cooled to monitor the formation of crystal impurities, as excess CaCO₃ and other contaminants could be present.

Thereafter, the solution was filtered again, transferred to another container, and further heated until the bulk of the solution until the solution was almost dried.

Subsequently, 95 mL of IPA was added to the sample under stirring to facilitate LiOH crystallization or precipitation. The sample was centrifuged to collect the product, yielding 3.63 g of LiOH·H₂O with purity of 99% or greater, and a recovery efficiency of 82%. The product was repeatedly washed in IPA four times.

(2) According to the method described in 3-(1), 50 mL of the washed solution including 21, 100 mg·L⁻¹ of lithium was allowed to pass through 20 g of Amberlite IRC 748, that is, ion exchange resin. A reaction with CaO was skipped considering the absence of CO₃²⁻. Thereafter, the ion-exchanged solution was evaporated until the bulk of the ion-exchanged solution was reduced. About 95 mL of IPA was added, and the product was washed three times in IPA until 5.8 g of high purity LiOH·H₂O (>99%) was collected with a recovery rate of 91%.

(3) Solid residues containing the reduced transition metal, separated from lithium according to method 2-(1), may be dissolved in an acid, such as sulfuric acid (1-3 M), with or without a small amount (0 to 0.5 wt %) of H₂O₂. Further treatment may be performed on the residues to produce individual salts of transition metals or NCM(OH)₂ or as cathode material precursors.

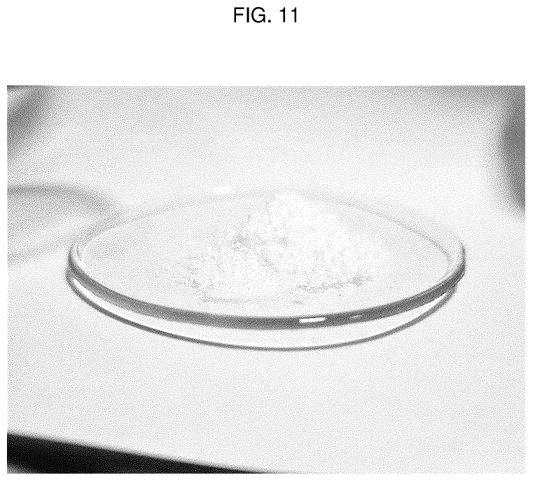

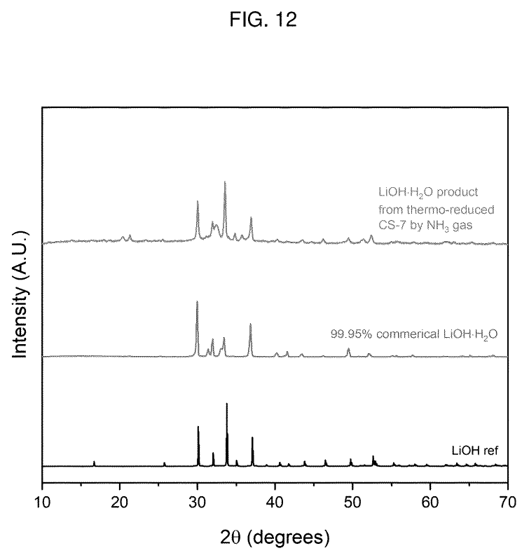

FIG. 11 is an image of the actual LiOH·H₂O that was derived from the thermally reduced CS-7 using NH₃ gas. FIG. 12 presents an XRD pattern of the LiOH·H₂O product that was derived from the selective lithium leaching the NH₃ gas-treated CS-7 at 550° C. The image of the actual LiOH·H₂O in FIG. 11 has a purity of 99% while the XRD pattern in FIG. 12 corresponds well to a commercial product having purity of 99.5%. Referring to FIGS. 11 and 12, these results indicate that the LiOH·H₂O product was successfully extracted from the NH₃ gas-treated CS-7 by selective Li leaching.

Accordingly, the method of manufacturing LiOH from a waste lithium-ion battery, as described in this embodiment, involves heat-treating the waste lithium-ion battery with NH₃ gas as a reducing agent. Cathode scraps (1 g to 10 g) of the waste lithium-ion battery were flushed with an inert gas, while NH₃ gas (100 to 500 mL·min⁻¹) was gradually supplied at a rising temperature (400° C. to 700° C.). To ensure effective reduction of the cathode scraps, the temperature was maintained at the final set point for 10 minutes to 3 hours. The thermo-chemical reduction step converted the transition metals (Me) into their respective lower-valent oxides (MeO) or zero-valent metallic states (Me), while the lithium component was converted into either lithium oxide (Li₂O) or LiOH, with a small amount of remaining Li₂CO₃ as trace contaminant. This method is applicable to waste lithium-ion batteries containing cathode materials with a general structure of LiMeO₂, including cathode scraps and black mass derived from NCM, LCO, and NCA composite oxides. Additionally, this embodiment describes a continuous process for the selective extraction of lithium from waste lithium-ion batteries through heat treatment, followed by water leaching, a CaO reaction (optional), ion exchange (optional), and evaporation-crystallization to produce LiOH·H₂O. As a result, this method proposes a simple and direct approach of producing LiOH as the first step of waste lithium-ion battery recycling process.

In an embodiment of the present disclosure, cathode scraps subjected to thermal reduction with ammonia gas achieved a lithium recovery efficiency of 88% to 93% through water leaching. The corresponding lithium composition contained 5 mol % or less of CO₃²⁻ and 95 mol % or more of OH⁻. After continuous steps, including CaO addition, ion exchange, and evaporation to convert all lithium into the OH⁻ form, the addition of IPA resulted in the precipitation of LiOH·H₂O, with an efficiency of 82% to 91%. The final product had a purity of 99% or more. Overall lithium recovery using this method ranged from 76% to 81%.

### DESCRIPTION OF REFERENCE NUMERALS

S5: purging step S10: thermo-chemical reduction step
S20: water leaching step S30: solid/liquid step (magnetic separation, centrifugation, membrane filtration, etc.)
S40: CaO addition and precipitate removal step
S50: ion exchange step S60: evaporation and filtration step
S70: crystallization step (solvent or evaporative)

What is claimed is:

1. A method of manufacturing LiOH from a lithium-ion battery waste, the method comprising:
a reduction step of heat-treating cathode scraps derived from a lithium-ion battery waste by heating the cathode scraps under an ammonia gas atmosphere; and
a leaching step of extracting lithium from the heat-treated cathode scraps using water.

2. The method of claim 1, wherein the cathode scraps have Chemical Formula 1:
LiCoₐMn_{b}Ni_{c}Al_{d}O₂ [Chemical Formula 1]
wherein each of a, b, c, and d is 0 or more and 1 or less, and if Li=1, a+b+c+d=1; if Li<1, 1<a+b+c+d<2; whereas if Li>1, 0<a+b+c+d<1.

3. The method of claim 1, wherein the reduction step comprises heat-treating the cathode scraps at a temperature of 300° C. to 700° C. for 20 minutes to 80 minutes.

4. The method of claim 1, further comprising a purging step, wherein the cathode scraps are purged with an inert gas prior to the reduction step.

5. The method of claim 1, further comprising a solid/liquid separation step for the removal of solid residues from the leached solution after the leaching step, wherein the separation is performed using filtration, centrifugation, magnetic separation, or other devices serving the same purpose.

6. The method of claim 5, further comprising a CaO addition and precipitate removal step, wherein CaO is added to the filtered leachate solution, and precipitates formed by reacting with CaO are removed from the leachate solution.

7. The method of claim 6, further comprising an ion exchange step, wherein the solution from which the precipitates have been following the CaO reaction is passed through ion exchange resin.

8. The method of claim 7, further comprising an evaporation step, wherein impurities are removed by evaporating a fraction of the ion-exchanged solution, after the ion exchange step.

9. The method of claim 8, further comprising a crystallization step, wherein the solution from which the impurities have been removed is crystallized or precipitated by either adding isopropyl alcohol (solvent crystallization) or by passing the solution in an evaporative crystallizer, after the evaporation step.

10. The method of claim 1, wherein, in the reduction step, the NH₃ gas is 100 mL·min⁻¹ to 2 L·min⁻¹.
